(19) United States
(12) Patent Application Publication
(10) Pub. No.: US 2004/0035761 A1
(43) Pub. Date: Feb. 26, 2004

(54) Pressurized screen for screening a fibrous suspension

(75) Inventors: Reimund Rienecker, Heidenheim (DE); Stefan Rippl, Ravensburg (DE)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenheim (DE)

(21) Appl. No.: 10/615,867

(22) Filed: Jul. 10, 2003

(30) Foreign Application Priority Data
Jul. 23, 2002 (DE) 102 33 364.5

(51) Int. Cl. B07B 1/20

(52) U.S. Cl. 209/306; 209/400; 209/305

(57) ABSTRACT

Pressurized screen for screening a fibrous suspension that includes intake chamber having an intake to guide the fibrous suspension into the intake chamber, and at least one wire element with a plurality of wire openings. The at least one wire element passes at least a portion of the fibrous suspension in the intake chamber and rejects at least a portion of the fibrous suspension in the intake chamber. A centrifuge rotor with apertures is positioned in the intake chamber so that at least a part the fibrous suspension in the intake chamber travels radially inwardly through the apertures and into the at least one wire element. A heavy material outlet removes at least a part of the fibrous suspension not traveling through the apertures. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 102 33 364.5, filed on Jul. 23, 2002, the disclosure of which is expressly incorporated by reference herein in its entirety.

### BACKGROUND OF THE INVENTION

1. Field of the Invention

The invention relates to a pressurized screen for screening a fibrous suspension with at least one wire element provided with a plurality of wire openings. A part of the fibrous suspension fed into an intake chamber of the screening device from an intake can pass through the at least one wire element, based on the dimensions of the fibrous material particles, e.g., fibers, contained in the part of the fibrous suspension, while another part of the suspension is rejected at the wire openings and separately guided away from the screening device.

2. Discussion of Background Information

Pressurized screens are used in the processing of paper fiber stock suspensions to process the fibrous suspension in a wet screening. In addition, such a pressurized screen contains at least one wire that is provided with a plurality of openings. The fibers contained in the suspension are to pass through the openings, while the undesirable solid constituents are rejected and guided out of the screen again. As a rule, round holes or slots are used as screen openings. In most cases pressurized screens of the type under consideration here are equipped with wire scrapers that are moved closely past the screen. The clogging of the screen openings is prevented by this in a manner known per se.

Thus, the separating effect of a pressurized screen is attributable to the fact that at least a part of the contaminants contained in the fed paper fiber stock suspension can not pass the screen, i.e., separated from the paper fibers based on size, shape, or flexibility. Pressurized screens are also known in which additionally a separation targeted specifically to the density of the contaminants is undertaken, in that the different forces of the contaminants in a centrifugal field are utilized. Even though the separating effect can be achieved optimally only in hydrocyclones and centrifuges, it can be useful in a weaker form in pressurized screens. Although a large part of the heavy material would not pass through the wire openings customarily used anyway, i.e., would be separated there, there is a danger of damage or wear when they come into contact with the wire. This risk is further heightened by the fact that scrapers are almost always used that move very closely past the screen at relatively high speed.

A pressurized screen is known from European Patent No. EP 0 726 981 B1 in which there is a conical rotating part (chunk collar) in the intake chamber that is intended to prevent heavy material from being drawn into the area of the wire with the paper fiber stock suspension. The heavy material is then to be removed by a heavy material outlet attached to the intake chamber. The effect is evidently not adequate, however. Attempts are being made to improve this device in that an additional stationary guide plate keeps the intake stream separated from the remaining suspension.

In the screen shown in European Patent Application No. EP 1 124 003 A2 for cleaning a fibrous suspension, a screen basket rotating concomitantly with the rotor is arranged upstream of the actual wire element, which basket serves to perform a prescreening. For protection of the surface of this screen basket from strongly abrasive heavy material, it is provided with concomitantly rotating cleaning blades that centrifuge the specifically heavy material outwards.

The pressurized screen in European Patent Application No. EP 0 473 354 A1 features a rotor that is cylindrically extended towards the top and is provided there with radial strips or radial blades. Between the intake chamber of the screen and the intake area to the actual wire element (wire basket), the suspension flows in the axial direction and thereby passes the strips or blades. Thus large and heavy material are centrifuged outwards and can be carried away.

### SUMMARY OF THE INVENTION

The present invention is directed to known pressurized screens that additionally provide that a part of the heavy material can be removed from the paper fiber stock suspension with simple devices, before they strike the wire element.

Accordingly, the present invention includes a driven centrifuge rotor situated in the intake chamber, which is connected to a heavy material outlet. The centrifuge rotor includes apertures through which the fibrous suspension can travel from the intake chamber radially from the outside inwardly into to the wire element. The apertures are slots whose longitudinal extent lies at a right angle or inclined to a circumferential motion direction of the centrifuge rotor, and the maximum opening width of the apertures, viewed in the circumferential direction, is at least 5 mm.

Moreover, the present invention also includes a driven centrifuge rotor situated in the intake chamber, which is connected to a heavy material outlet. The centrifuge rotor includes a disk arranged at right angles to an axis of rotation that is positioned to form a ring-shaped gap through which the fibrous suspension can travel from the intake chamber radially inwardly into the screen wire. The axial width of the ring-shaped gap is at most 100 mm.

With the aid of the rotor formed according to the invention and positioned in the intake chamber, it is possible to produce a sufficient rotational speed in the inflowing fibrous suspension so that a considerable part of the heavy material contained therein can be removed from the flow at an early stage. The heavy material is seized by a strong swirling flow and thereby guided to the outer wall of the intake chamber. During the transport from the intake chamber to the wire element, the suspension flows radially from the outside inwards, which utilizes the produced centrifugal forces particularly effectively for removal of the heavy material. Therefore, the rotor can, unlike, e.g., a rotating prescreen, which must also develop screening effects, be structured in a relatively rough manner. If it is provided with apertures, the area in which these apertures are situated is advantageously formed in a cylindrical shape, which is simple to construct. If desired, static scraping elements can also be attached on the downstream side of the rotor, which elements in cooperation with the motion of rotation of the rotor lead to a possibly desirable additional deflaking of the fibrous material. The static scraping elements should be at a distance of one to several millimeters from the centrifuge rotor being moved past them, in order to prevent contaminants from being reduced inadmissibly or the power consumption being unnecessarily high. A clogging of the spaces between these static scraping elements need not be feared, not least because an extremely efficient scraping effect is generated by the rotor.

The pressurized screen is used to particular advantage in recovered paper processing, especially when the fibrous material is still relatively strongly soiled. The wire element downstream of the centrifuge rotor can be disk-shaped or cylindrical. Disk-shaped wire elements are particularly robust, which is important in recovered paper processing.

Another typical use is the screening after the slushing of paper machine broke. Although this is normally only very slightly soiled, heavy material, e.g. screws, can get into it, which would damage the wire of the pressurized screen or downstream apparatus. However, this happens extremely seldom, so that the use of hydrocyclones is disproportionate for this heavy material alone.

The present invention is directed to a pressurized screen for screening a fibrous suspension that includes an intake chamber having an intake structured and arranged to guide the fibrous suspension into the intake chamber, and at least one wire element with a plurality of wire openings. The at least one wire element is structured and arranged to pass at least a portion of the fibrous suspension in the intake chamber and to reject at least a portion of the fibrous suspension in the intake chamber. A centrifuge rotor with apertures is positioned in the intake chamber, and the centrifugal rotor is structured and arranged so that at least a part the fibrous suspension in the intake chamber travels radially inwardly through the apertures and into the at least one wire element. A heavy material outlet is arranged to remove at least a part of the fibrous suspension not traveling through the apertures.

In accordance with a feature of the invention, the portion of the fibrous suspension passing the at least one wire element can be based on dimensions of fibrous material particles with the fibrous suspension. The fibrous material particles may include fibers.

According to another feature of the invention, the centrifugal rotor can include a driven centrifuge rotor.

The apertures may include slots having a longitudinal extent oriented one of at a right angle to or obliquely to a circumferential motion direction of the centrifuge rotor. A maximum opening width of the apertures, viewed in the circumferential direction, can be at least 5 mm. The maximum opening width of the apertures, viewed in the circumferential direction, may be at least 20 mm.

According to still another feature of the present invention, the centrifuge rotor can include a cylindrical part in which the apertures are located.

In accordance with a further feature of the instant invention, the intake can be arranged to be axially displaced from the apertures.

The pressurized screen can further include a housing to contain the pressurized screen. The intake may be tangentially coupled to the housing.

Moreover, the pressurized screen can include a housing containing the pressurized screen, in which the intake is centrally located in the housing.

In accordance with another feature of the present invention, the slots may be continuous in the axial direction.

A total surface of all the apertures is at least 40% of a surface that the centrifuge rotor includes in an area of the apertures.

The pressurized screen may also include stator elements arranged so that a shortest distance from the centrifuge rotor to the stator elements is between 1 and 10 mm. The stator elements can be arranged downstream of the apertures in a flow direction of the fibrous suspension.

According to still another feature of the invention, the wire element may be in the shape of a cylinder.

Further still, an axial extent of the apertures is between 5% and 25% of an axial extent of the at least one wire element.

The present invention is directed to a pressurized screen for screening a fibrous suspension that includes an intake chamber having an intake structured and arranged to guide the fibrous suspension into the intake chamber, and at least one wire element with a plurality of wire openings. The at least one wire element is structured and arranged to pass at least a portion of the fibrous suspension in the intake chamber and to reject at least a portion of the fibrous suspension in the intake chamber. A centrifuge rotor with apertures is positioned in the intake chamber, and the centrifugal rotor is structured as a disk oriented at right angles to an axis of rotation and arranged to form a ring-shaped gap through which at least a part the fibrous suspension in the intake chamber travels radially inwardly and into the at least one wire element. A heavy material outlet is arranged to remove at least a part of the fibrous suspension not traveling through the apertures.

According to a feature of the instant invention, the ring-shaped gap has an axial width of at most 100 mm.

In accordance with another feature of the invention, the axial width of the ring-shaped gap can be at most 10 mm.

According to still another feature of the present invention, the disk can be closed.

The pressurized screen can further include a drivable wire scraper structured and arranged to keep the at least one wire element clear. The drivable wire scraper and the centrifuge rotor may be connected to a same rotor.

An outside diameter of the centrifuge rotor can be at least a same size of an outside diameter of the at least one wire element. Further, the outside diameter of the centrifugal rotor may be is at least 1.2 times the size of the outside diameter of the at least one wire element.

The pressurized screen may further comprise radially extending centrifuge ribs coupled to the centrifuge rotor. An outside diameter of the centrifuge rotor can include toothed blades.

The present invention is directed to a pressurized screen for screening a fibrous suspension that includes an intake chamber structured and arranged to receive the fibrous suspension, and at least one wire element with a plurality of wire openings. The at least one wire element is being structured and arranged to pass at least a portion of the fibrous suspension in the intake chamber and to reject at least a portion of the fibrous suspension in the intake chamber. A centrifuge rotor with apertures is positioned in the intake chamber, and the centrifugal rotor is structured and arranged to pass the portions of the fibrous suspension to be passed and rejected by the at least one wire element and to reject the remainder of the fibrous suspension in the intake chamber. A reject outlet is arranged to receive the remainder of the fibrous suspension in the intake chamber.

In accordance with still yet another feature of the present invention, a drivable wire scraper is structured and arranged to keep the at least one wire element clear. Further, the drivable wire scraper and the centrifuge rotor are connected to a same rotor drive.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates, in section, a pressurized screen according to the invention;

FIG. 2 illustrates an upper part of a pressurized screen according to the invention in a varied form of embodiment;

FIGS. 3 and 4 illustrate, in detail, various embodiments of the centrifuge rotor depicted in FIG. 1;

FIG. 5 illustrates a partial view of a variation of the intake chamber;

FIG. 6 diagrammatically illustrates a sectional side view of another embodiment of the pressurized screen according to the invention;

FIG. 7 illustrates a disk-shaped centrifuge rotor; and

FIG. 8 illustrates another centrifuge rotor with a cylindrical part.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

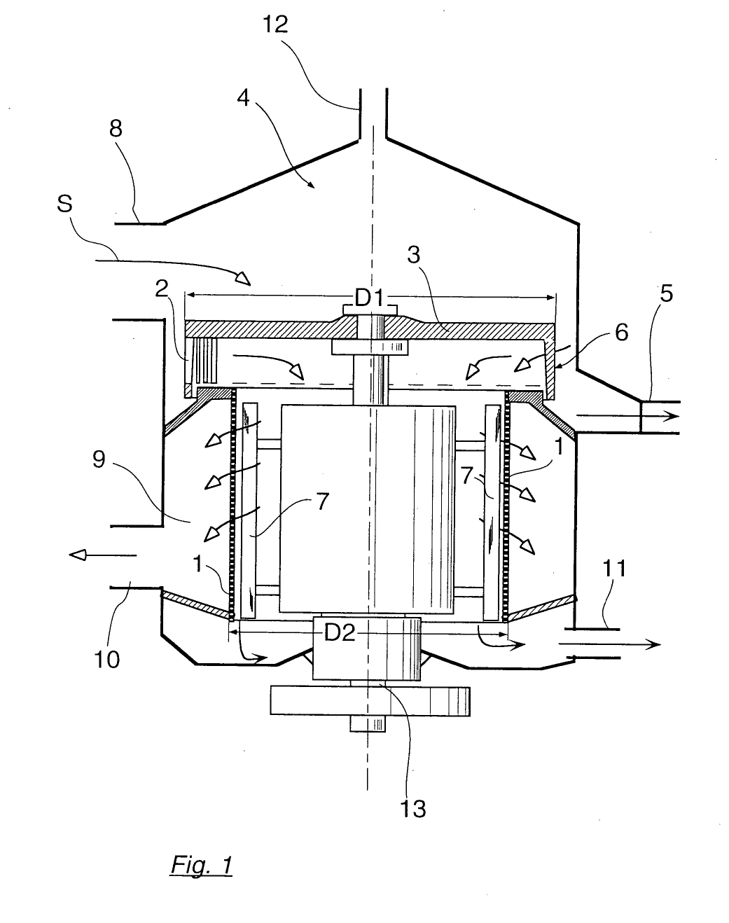

FIG. 1 shows an embodiment of the pressurized screen according to the instant invention, in which fibrous suspension S to be screened first arrives in an intake chamber 4, in which a centrifuge rotor 3 is also situated. In the illustrated example, centrifugal rotor 3 has a cylindrical part 6 that is provided with a large number of apertures 2, of which only some are diagrammatically illustrated. Through these apertures 2, fibrous suspension S travels from intake chamber 4 radially from the outside inwardly and can then flow into wire element 1. In the exemplary embodiment, wire element 1 is formed as a cylindrical wire basket. The part of fibrous suspension S that can pass through the screen openings of wire element 1 arrives in accepted stock chamber 9 and then through accepted stock outlet 10 back into the processing process. The portions of fibrous suspension S that do not passed through screen element 1 are guided away from the pressurized screen again through reject outlet 11.

It is important for the function of the pressurized screen according to the invention that intake chamber 4 is connected to a heavy material outlet 5 that is situated here at the outer diameter of intake chamber 4. It can, e.g., be tangentially attached to intake chamber 4 and lead into a heavy material sluice. Another possibility is the continuous guiding of a partial stream containing heavy material, which, although it is more laborious, is less disruptive to the process. The deciding factor is that the heavy material centrifuged out by the rotational motion of centrifuge rotor 3 can be carried away optimally.

It can also be advantageous for a light material outlet 12 to be present in the center of intake chamber 4, since, as a result of the swirling flow, light material, e.g., Styropor® polystyrene or air, are driven to the middle. Intake 8 for fibrous suspension S to intake chamber 4 can be a tangential intake, in order to support the swirling flow in intake chamber 4. Intake 8 is axially displaced with respect to centrifuge rotor 3. The inflowing fibrous suspension S can then be accelerated to the rotational speed of centrifuge rotor 3, without too many damaging eddies being formed.

It is favorable if the outside diameter D1 of centrifuge rotor 3 is selected to be relatively large, because this makes it possible to achieve a greater centrifugal effect even at moderate circumferential velocities. Thus, e.g., outside diameter D1 of centrifuge rotor 3 can preferably be about 20% greater than outside diameter D2 of wire element 1. These data relate to pressurized screens with a cylindrical wire element. Customarily, wire element 1 is kept clear by wire scrapers 7 that are part of a rotor 13. It is generally advisable to concomitantly drive centrifuge rotor 3 by this rotor 13. This results in optimal speed conditions when centrifuge rotor 3 has a greater outside diameter D1 than wire element 1.

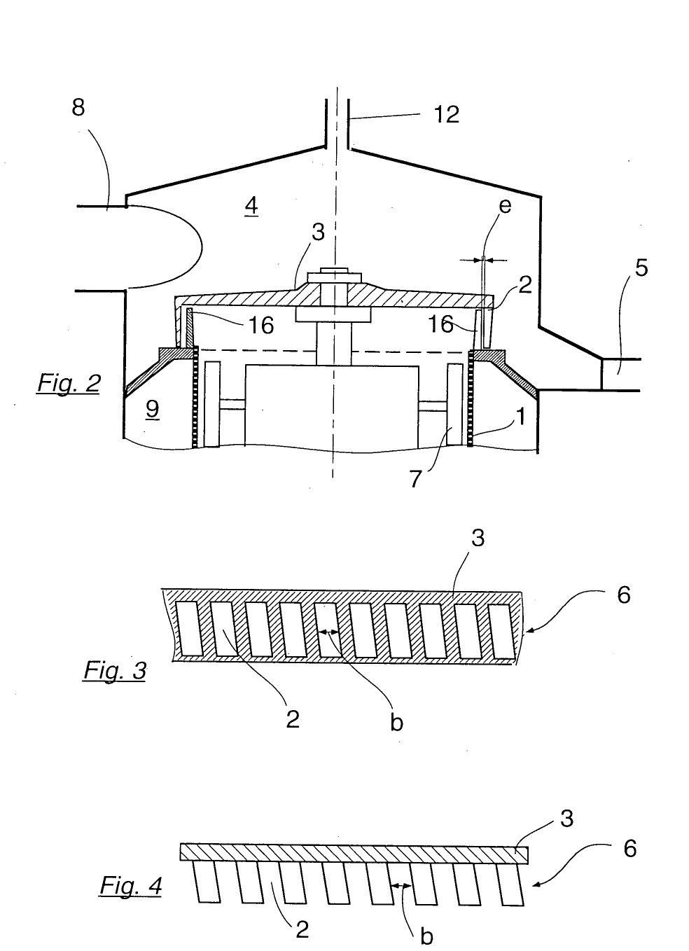

As shown in FIG. 2, on a flow-through side of centrifuge rotor 3, stator elements 16 can be attached at apertures 2 in order to effect the slushing of larger scraps of paper and/or prevent a clogging of apertures 2. Stator elements 16 are to be viewed as a special solution to certain problems.

In FIGS. 3 and 4, two examples of apertures 2 on centrifuge rotor 3 are shown in somewhat more detail. Opening width b of apertures 2 can normally be selected to be relatively large, e.g., 5 or 10 mm, since these are not wire openings like those of wire element 1. As is known, wire openings have the function, due to their geometry, of not allowing the too large constituents of the suspension to pass through. The size relationship of the pass-through surface relative to the total surface of the cylindrical part of the centrifuge rotor 3 is advantageously at least 40%. Due to the completely different requirements, wire elements in pressurized screens manage with less than half. The sides of apertures 2 can preferably be inclined, in order to cause hanging parts to slip off. According to FIG. 3, they can be closed openings and, according to FIG. 4, the openings can be open in order to form projecting teeth. Of course, other openings, e.g., round or oval, are also conceivable.

Intake chamber 4, differing from the shapes shown in FIGS. 1 and 2, can also be embodied according to FIG. 5, such that fibrous suspension S flows in centrally in the axial direction. This allows a particularly low-eddy flow to be formed. FIG. 5 illustrates, as an additional feature, centrifuge ribs 17, which are arranged to accelerate the arriving flow of fibrous suspension S in intake chamber 4 in the circumferential direction. Centrifuge ribs 17 can also be advantageous with other forms of the invention.

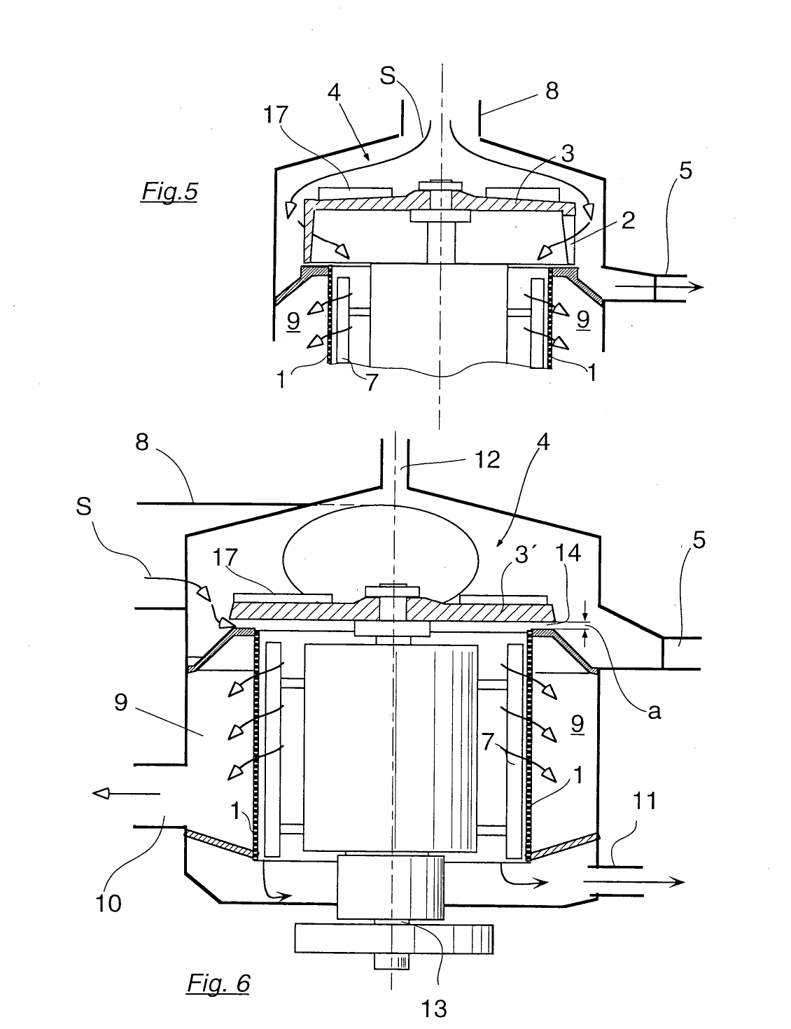

FIG. 6 shows a form of embodiment in which centrifuge rotor 3′ is disk-shaped and forms a ring-shaped gap 14 through which fibrous suspension S can travel from intake chamber 4 radially inwards to wire element 1. This form of centrifuge rotor 3′ is considerably more space-saving and simpler. The energy consumption should also be lower. The axial width a of ring-shaped gap 8 is maximally 100 mm, in order to prevent heavy material from being sucked into the area of wire element 1. However, they can also be considerably smaller, e.g., with a value of between 3 and 10 mm. If the width is too large, a flow with too low rotational speed could develop in the vicinity of the non-rotating wall of the ring-shaped gap.

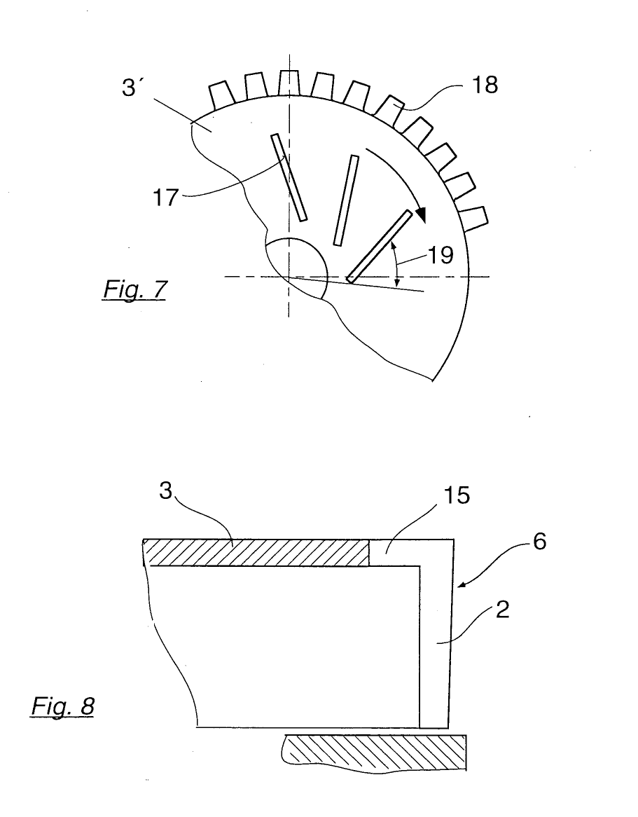

As FIG. 7 shows, a disk-shaped centrifuge rotor 3′ can also be provided at its outside diameter with toothed blades 18, of which only a part is drawn. With these toothed blades 18 the necessary rotational speed in the suspension is produced particularly simply and effectively by means of the rotation of centrifuge rotor 3′. Toothed blades 18 are situated in the area of ring-shaped gap 14. Centrifuge ribs 17 can also be recognized in top view in this figure. They are advantageously inclined with respect to the radials by an angle 19 that can, e.g., be about 30°. Curved shapes are also conceivable for such centrifuge ribs.

In special forms of embodiment, in addition to apertures 2, other openings can be present for fibrous suspension S in the disk-shaped part of the centrifuge rotor. This is shown in FIG. 8 using as an example centrifuge rotor 3 with a cylindrical part 6. In order to achieve a larger free pass-through surface, on such a rotor, additional openings 15 can be incorporated into the disk-shaped part of rotor 3 that form a continuation of apertures 2.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A pressurized screen for screening a fibrous suspension comprising:
an intake chamber having an intake structured and arranged to guide the fibrous suspension into said intake chamber;
at least one wire element with a plurality of wire openings, said at least one wire element being structured and arranged to pass at least a portion of the fibrous suspension in said intake chamber and to reject at least a portion of the fibrous suspension in said intake chamber;
a centrifuge rotor with apertures positioned in said intake chamber, said centrifugal rotor being structured and arranged so that at least a part the fibrous suspension in said intake chamber travels radially inwardly through said apertures and into said at least one wire element; and
a heavy material outlet arranged to remove at least a part of the fibrous suspension not traveling through said apertures.

2. The pressurized screen in accordance with claim 1, wherein said portion of the fibrous suspension passing said at least one wire element is based on dimensions of fibrous material particles with the fibrous suspension.

3. The pressurized screen in accordance with claim 2, wherein said fibrous material particles comprise fibers.

4. The pressurized screen in accordance with claim 1, wherein said centrifugal rotor comprises a driven centrifuge rotor.

5. The pressurized screen in accordance with claim 1, wherein said apertures comprise slots having a longitudinal extent oriented one of at a right angle to or obliquely to a circumferential motion direction of said centrifuge rotor.

6. The pressurized screen in accordance with claim 5, wherein a maximum opening width of said apertures, viewed in said circumferential direction, is at least 5 mm.

7. The pressurized screen in accordance with claim 6, wherein said maximum opening width of said apertures, viewed in said circumferential direction, is at least 20 mm.

8. The pressurized screen in accordance with claim 1, wherein said centrifuge rotor comprises a cylindrical part in which said apertures are located.

9. The pressurized screen in accordance with claim 1, wherein said intake is arranged to be axially displaced from said apertures.

10. The pressurized screen in accordance with claim 1, further comprising a housing containing said pressurized screen,
wherein said intake is tangentially coupled to said housing.

11. The pressurized screen in accordance with claim 1, further comprising a housing containing said pressurized screen,
wherein said intake is centrally located in said housing.

12. The pressurized screen in accordance with claim 1, wherein said slots are continuous in the axial direction.

13. The pressurized screen in accordance with claim 1, wherein a total surface of all said apertures is at least 40% of a surface that the centrifuge rotor includes in an area of said apertures.

14. The pressurized screen in accordance with claim 1, further comprising stator elements arranged so that a shortest distance from said centrifuge rotor to said stator elements is between 1 and 10 mm.

15. The pressurized screen in accordance with claim 14, wherein said stator elements are arranged downstream of said apertures in a flow direction of said fibrous suspension.

16. The pressurized screen in accordance with claim 1, wherein said wire element is in the shape of a cylinder.

17. The pressurized screen in accordance with claim 1, wherein an axial extent of said apertures is between 5% and 25% of an axial extent of said at least one wire element.

18. A pressurized screen for screening a fibrous suspension comprising:
an intake chamber having an intake structured and arranged to guide the fibrous suspension into said intake chamber;
at least one wire element with a plurality of wire openings, said at least one wire element being structured and arranged to pass at least a portion of the fibrous suspension in said intake chamber and to reject at least a portion of the fibrous suspension in said intake chamber;
a centrifuge rotor with apertures positioned in said intake chamber, said centrifugal rotor being structured as a disk oriented at right angles to an axis of rotation and arranged to form a ring-shaped gap through which at least a part the fibrous suspension in said intake chamber travels radially inwardly and into said at least one wire element; and
a heavy material outlet arranged to remove at least a part of the fibrous suspension not traveling through said apertures.

19. The pressurized screen in accordance with claim 18, wherein said portion of the fibrous suspension passing said at least one wire element is based on dimensions of fibrous material particles with the fibrous suspension.

20. The pressurized screen in accordance with claim 19, wherein said fibrous material particles comprise fibers.

21. The pressurized screen in accordance with claim 18, wherein said centrifugal rotor comprises a driven centrifuge rotor.

22. The pressurized screen in accordance with claim 18, wherein said ring-shaped gap has an axial width of at most 100 mm.

23. The pressurized screen in accordance with claim 18, wherein said axial width of said ring-shaped gap is at most 10 mm.

24. The pressurized screen in accordance with claim 18, wherein said disk is closed.

25. The pressurized screen in accordance with claim 18, further comprising a drivable wire scraper structured and arranged to keep said at least one wire element clear.

26. The pressurized screen in accordance with claim 25, wherein said drivable wire scraper and said centrifuge rotor are connected to a same rotor.

27. The pressurized screen in accordance with claim 1, wherein an outside diameter of said centrifuge rotor is at least a same size of an outside diameter of said at least one wire element.

28. The pressurized screen in accordance with claim 27, wherein said outside diameter of said centrifugal rotor is at least 1.2 times the size of said outside diameter of said at least one wire element.

29. The pressurized screen in accordance with claim 18, further comprising radially extending centrifuge ribs coupled to said centrifuge rotor.

30. The pressurized screen in accordance with claim 29, wherein an outside diameter of said centrifuge rotor comprises toothed blades.

31. A pressurized screen for screening a fibrous suspension comprising:
an intake chamber structured and arranged to receive the fibrous suspension;
at least one wire element with a plurality of wire openings, said at least one wire element being structured and arranged to pass at least a portion of the fibrous suspension in said intake chamber and to reject at least a portion of the fibrous suspension in said intake chamber;
a centrifuge rotor with apertures positioned in said intake chamber, said centrifugal rotor being structured and arranged to pass the portions of the fibrous suspension to be passed and rejected by said at least one wire element and to reject the remainder of the fibrous suspension in said intake chamber; and
a reject outlet to receive the remainder of the fibrous suspension in said intake chamber.

32. The pressurized screen in accordance with claim 31, further comprising a drivable wire scraper structured and arranged to keep said at least one wire element clear.

33. The pressurized screen in accordance with claim 32, wherein said drivable wire scraper and said centrifuge rotor are connected to a same rotor drive.
